(19) United States
(12) Patent Application Publication
(10) Pub. No.: US 2016/0314452 A1
(43) Pub. Date: Oct. 27, 2016

(54) MOBILE DEVICE SECURE PAYMENT ACCEPTANCE FOR IN-STORE SHOPPING

(71) Applicant: MasterCard International Incorporated, Purchase, NY (US)

(72) Inventors: Sebastien Pochic, Brussels (BE); Fikret Ates, Namur (BE); Erik Lukas Ekselius, Overijse (BE)

(21) Appl. No.: 14/694,114

(22) Filed: Apr. 23, 2015

(51) Int. Cl. G06Q 20/32

(52) U.S. Cl. CPC G06Q 20/325; G06Q 20/322

(57) ABSTRACT

Methods and systems for facilitating operation of mobile devices as either consumer payment devices and/or merchant payment devices for completing purchase transactions. A process includes a consumer mobile device initializing a two-sided payment application, receiving a handshake indication at a merchant location from a merchant device running a copy of the two-sided payment application, and establishing a communications path between the consumer mobile device and the merchant device via a remote network connection. Purchase transaction detail data is then exchanged, the purchase transaction detail data is transmitted to a mobile gateway computer for authorization processing, and both the mobile device processor and the merchant device processor receive an authorization message to consummate the purchase transaction.

### FIELD OF THE DISCLOSURE

Embodiments described herein generally relate to methods and systems that facilitate operation of mobile devices as either consumer payment devices and/or merchant payment devices for purposes of completing a purchase transaction. In particular, a two-sided payment application is provided to a consumer mobile device and to a merchant device. After registration, the consumer initializes the two-sided payment application and the consumer's mobile device receives a handshake indication from a merchant device, and then participates in a remote exchange of transaction details with the merchant device. In some embodiments, the consumer's mobile device next transmits a purchase transaction authorization message to a payment gateway and receives advice of the outcome along with the merchant device. Thus, an in-application remote payment process is provided which can be accomplished according to various mechanisms and occur in accordance with any specified security level.

### BACKGROUND

Portable electronic devices, such as smartphones, tablet computers, digital music players and the like, have been developed that include desirable functionality and thus the number of mobile device users and/or owners keeps growing. Such mobile devices can store all types of information, including for example, multi-media data, application data (e.g., contacts or calendar events), text documents, or any combination thereof, and can perform many different types of functions for users. For example, users can load one or more applications onto their mobile devices to provide functionality related to one or more of games, business, education, finance, healthcare, lifestyle, navigation, news, productivity, reference, social networking, sports, utilities, travel, and/or weather.

Persons utilizing portable electronic devices typically use them to generate and/or access information (e.g., data or application displays) that may be shared with others. The information can be shared by using several different methods, for example, a consumer can show an image to another person on his or her electronic device display, and/or can send an e-mail, text or media message, or other message over a communications link to the other person's mobile device. The e-mail or other type of message can include information incorporated into and/or attached to the message. The receiving person can then view the information from such a communication, and could copy and/or save the information as desired. In some implementations, two electronic devices form a direct communications path between them. For example, a first mobile device can share a key with a second mobile device over a communications network (for example, a passkey in a Bluetooth network) to establish a secure communications path. In another example, two electronic devices can detect the same or similar accelerometer output, and use that accelerometer output as a key to set up a secure communications path. These approaches, however, require a user to generate or enter a key, or require a particular component in the device (e.g., an accelerometer or other sensor). In any case, after two mobile devices share a common communications path different types of data can be shared. For example, the mobile devices can share information and/or data on an application level (for example, share calendars and/or date information between two instances of a calendar application operating on the two different devices). Common types of data and/or information that is shared between applications includes photos, videos, and/or contacts information.

The overall popularity of mobile devices has led to the development of processes for using them to conduct financial transactions. Accordingly, some manufacturers have incorporated the capabilities and/or components of a contactless payment card or proximity payment card (or “chip” card) into their mobile devices, such as mobile telephones, personal digital assistants (PDAs), tablet computers and the like, in order to facilitate contactless purchase transactions for consumers. For example, mobile telephone manufacturers may include a payment processor/transceiver integrated circuit (IC) configured for contactless communications with a contactless reader device associated with a point of sale (POS) terminal of a merchant. In such embodiments, a smartphone includes conventional mobile telephone circuitry for making wireless calls in addition to IC payment circuitry and/or other hardware for providing near field communication (NFC) functionality so that the mobile telephone can be used as a contactless payment device.

However, many mobile devices do not have specialized NFC components configured for facilitating contactless payments. Thus, processes have been developed so that such mobile devices can operate to transmit payment between a payer and a recipient (or payee). For example, in an implementation, payment is transmitted by a payer to a payee by using the payer's and/or the payee's cellular telephone number as an identifier. Problems can arise, however, because this method assumes that the payee has a mobile telephone which is capable of receiving payments. In addition, the payer must know or be supplied with the payee's telephone number. Since some people frequently change mobile telephone (or cellular) phone numbers, a mechanism must be in place so that the payer can check to be certain that the payee telephone number being used for a particular transaction is the correct number. Otherwise, the payer may end up transmitting a payment to an unintended third party. Furthermore, such an implementation fails when the payer and/or the payee does not wish to reveal personal information, such as their cellular telephone number, to the other party in the transaction. Thus, a need exists for methods and systems to facilitate the use of mobile devices, which may lack NFC components, as payment devices that can be used to consummate purchase transactions.

### BRIEF DESCRIPTION OF THE DRAWINGS

Features and advantages of some embodiments of the present disclosure, and the manner in which the same are accomplished, will become more readily apparent upon consideration of the following detailed description taken in conjunction with the accompanying drawings, which illustrate exemplary embodiments and which are not necessarily drawn to scale, wherein:

FIG. 1 is a block diagram illustrating components of a digital remote payment acceptance system in accordance with embodiments of the disclosure;

FIG. 2 is a block diagram of an embodiment of a consumer mobile device to illustrate some hardware aspects of embodiments in accordance with the disclosure;

FIG. 3 is a block diagram of a secure element of a consumer payment-enabled mobile device to illustrate software aspects according to embodiments of the disclosure;

FIG. 4 is a flowchart of a two-sided payment application transaction process between a consumer mobile device and a merchant device in accordance with aspects of the disclosure;

FIG. 5 is a flowchart of a two-sided payment application transaction process from the point of view of the merchant utilizing a merchant device in accordance with aspects described herein; and

FIG. 6 is a schematic block diagram of an unattended location wherein a merchant device includes a two-sided payment application operable to conduct payment transactions with consumer mobile devices in accordance with embodiments of the disclosure.

### DETAILED DESCRIPTION

Reference will now be made in detail to various novel embodiments, examples of which are illustrated in the accompanying drawings. It should be understood that the drawings and descriptions thereof are not intended to limit the invention to any particular embodiment(s). On the contrary, the descriptions provided herein are intended to cover alternatives, modifications, and equivalents thereof. In the following description, numerous specific details are set forth in order to provide a thorough understanding of the various embodiments, but some or all of these embodiments may be practiced without some or all of the specific details. In other instances, well-known process operations have not been described in detail in order not to unnecessarily obscure novel aspects.

In general, and for the purpose of introducing concepts of novel embodiments described herein, described are systems and processes for facilitating payment transactions in-store or at a merchant location between a first mobile device of a consumer and a merchant device, which may be a second mobile device. In the embodiments described herein, remote technologies, which are typically utilized to facilitate communications between mobile devices, are utilized to facilitate face-to-face transactions, such as a purchase transaction between a consumer utilizing a mobile device in a retail store and a merchant who is also using a mobile device. Such transactions can occur in many different types of environments, such as attended stores wherein one or more merchant employees (such as sales clerks manning electronic checkout devices, which may be mobile devices as described herein) are present to conduct purchase transactions. Embodiments described herein may also be utilized to facilitate a consumer purchase transaction using a consumer mobile device in unattended environments, such as a consumer purchasing gasoline with a consumer mobile device at a gasoline station gas pump wherein the gasoline station is outfitted with a merchant device operable to function in accordance with the novel aspects described herein. Examples of other unattended environments in which a consumer may use his or her mobile device in accordance with the novel process embodiments described herein include, but are not limited to, roadway toll booths, mass transit entrance turnstiles, vending machines, municipal parking meters, and/or metered or timed parking lot exit gates.

In some embodiments, a first mobile device is provided with a two-sided payment application and a second mobile device is provided with the same two-sided payment application, which may be accomplished in different ways. For example, a mobile network operator may push the two-sided payment application to its mobile telephone customers as part of an operating system update or upgrade.

In some embodiments, after loading the two-sided payment application, the consumer registers or enrolls by providing various types of data and/or information and the merchant does the same. Thus, when a consumer activates his or her two-sided payment application on a consumer mobile device, that mobile device listens for a handshake indication (such as a signal) from the merchant device (which may be a merchant's mobile device). Thus, the consumer's two-sided payment application initially acts as a detector. Accordingly, in some implementations a merchant may initialize the two-sided payment application on his or her mobile device to present or transmit or otherwise provide a handshake indication for detection by the consumer's two-sided payment application. Thus, the merchant's two-sided payment application initially acts as a beacon.

When the consumer's mobile device recognizes the handshake indication then a handshake operation is triggered, which causes preparations to occur for exchanging transaction details with the merchant's mobile device via a remote network. A communications path is established between the consumer's mobile device and the merchant's mobile device via a remote network connection, which may be a secure connection. In some implementations, transaction details, such as the transaction amount, transaction time and date, a transaction code, merchandise data (which may be itemized and/or presented as line items), and/or other transaction details are exchanged via the internet between the consumer's mobile device and the merchant's mobile device. In some implementations, the consumer's mobile device can transmit or “push” the transaction details, while in other embodiments the merchant mobile device may “pull” the purchase transaction details from a merchant point-of-sale (POS) system. It should also be understood that, once the handshake process has occurred, the consumer's mobile device is connected to the merchant's device. Thus, many other types of information and/or data may be exchanged between the consumer's mobile device and the merchant's device. For example, the consumer's mobile device may transmit consumer data to the merchant's device, such as the consumer's name, residence address and/or billing address, preferences data, loyalty card program data, rewards data, coupon data, and the like. The merchant's device may receive such consumer data and store it for future use, and may also transmit merchant data to the consumer's mobile device, such as merchant name, store address, discount offers, and the like. The consumer may then decide whether or not to purchase additional or different items depending on the merchant's communications.

In some embodiments, the purchase transaction process continues with the consumer's mobile device transmitting the purchase transaction data to a payment gateway computer network for authentication and authorization processing. If the consumer is authenticated and the purchase transaction is authorized, then the consumer's mobile device receives an authorization message from the payment gateway network, and the merchant's mobile device also receives the authorization message from the payment gateway network to consummate the transaction. Such a two-sided purchase application process is easy to implement and is secure, and appears to the consumer to have been handled locally, in the merchant's retail location. Thus, this type of payment transaction process may be considered to be an in-application payment method which can be secured utilizing a tokenization method, and it can be accomplished with various mechanisms and at different security levels.

A number of terms will be used herein. The use of such terms are not intended to be limiting, but rather are used for convenience and ease of exposition. For example, as used herein, the term “cardholder” may be used interchangeably with the term “consumer” and are used herein to refer to a consumer, person, individual, business or other entity that owns (or is authorized to use) a financial account such as a payment card account (such as a credit card account). In addition, the term “payment card account” may include a credit card account, a debit card account, and/or a deposit account or other type of financial account that an account holder may access. The term “payment card account number” includes a number that identifies a payment card system account or a number carried by a payment card, and/or a number that is used to route a transaction in a payment system that handles debit card and/or credit card transactions and the like. Moreover, as used herein the terms “payment card system” and/or “payment network” refer to a system and/or network for processing and/or handling purchase transactions and related transactions, which may be operated by a payment card system operator such as MasterCard International Incorporated, or a similar system. In some embodiments, the term “payment card system” may be limited to systems in which member financial institutions (such as banks) issue payment card accounts to individuals, businesses and/or other entities or organizations.

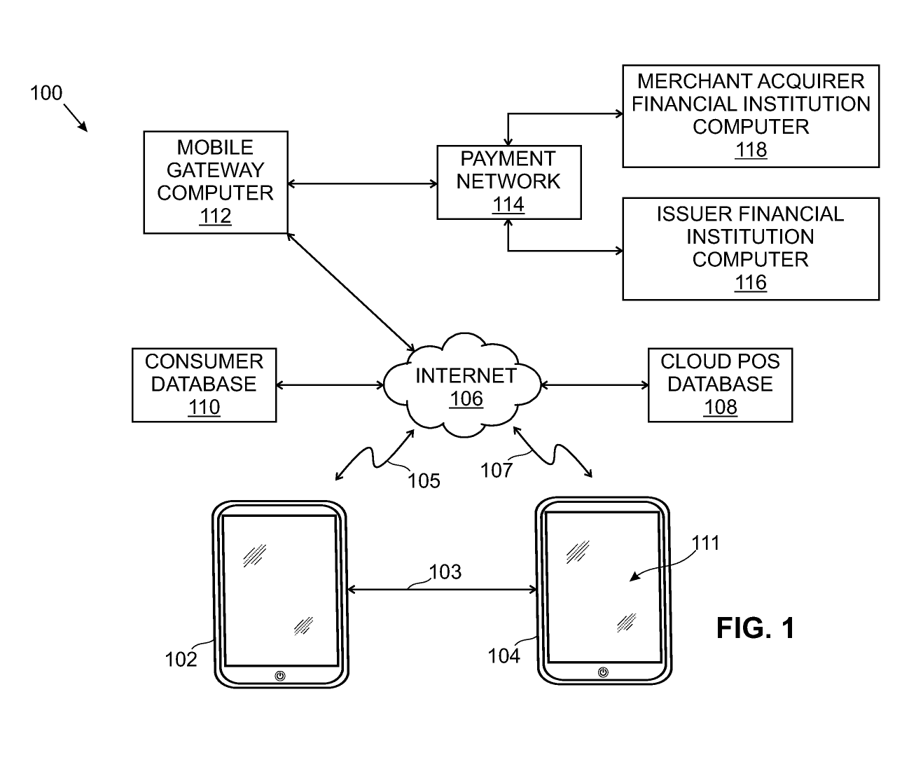

FIG. 1 is a block diagram illustrating components of a digital remote payment acceptance system 100 in accordance with embodiments described herein. A consumer (not shown) has a mobile device 102 that includes a two-way payment application, and a merchant has a mobile device 104 that also includes the same two-way payment application. It should be understood, however, that the merchant may utilize another type of electronic device instead of the mobile device 104. For example, the merchant may utilize a specialized electronic device, such as an electronic Point-of-Sale (POS) device (such as an electronic cash register or desktop computer, not shown) having a display screen and one or more electronic components configured to initiate the handshake operation and establish communications with the consumer mobile device 102 as described herein. Such an electronic POS device also is capable of receiving information and/or data from remote computers and/or computer networks in the manner described herein.

Referring again to the example system 100 of FIG. 1, the consumer mobile device 102 and merchant mobile device 104 are configured for communications via the internet 106, and with a cloud Point-of-Sale (POS) database 108 and/or a consumer database 110. The POS database 108 and consumer database 110 are shown as separate databases for ease of reference, but may be, in some embodiments, a combination database such as a two-way payment application database that includes data related to both consumers and merchants in accordance with the processes described herein. A mobile gateway computer server 112 is also configured for communicating with the consumer mobile device 102 and/or the merchant mobile device 104 via the internet 106. The mobile gateway computer 112 is also operably connected to a payment network 114, which is operably connected to an issuer financial institution (FI) computer 116 and to a merchant acquirer FI computer 118. It should be understood that some of the various components shown in FIG. 1 may be a subset of a larger system, and that more or less components and/or devices may be utilized. For example, although only one issuer FI computer 116 and one merchant acquirer FI computer 118 are shown, in some practical embodiments a plurality of such components, as well as a plurality of payment networks and/or mobile gateway computers, may be utilized. In addition, although specific embodiments are described herein, it should be understood that this is for illustrative purposes only and that different components and/or configurations could be used without departing from the spirit and scope of this disclosure.

In some embodiments, the two-sided payment application is factory-installed on the consumer's mobile device, or it may be downloaded by a person or consumer onto his or her consumer mobile device 102 (for example, onto an iPhone™ or an Android™ smartphone, a tablet computer such as an iPad™, a laptop computer, a digital music player, a personal digital assistant (PDA) and the like). Thus, the two-sided payment application may be provided to the consumer by the manufacturer of a mobile device, and/or may be available from or provided by a mobile network operator (MNO) associated with the consumer, or may be available from the consumer's issuer financial institution (i.e., issuer bank of the consumer's payment card account), and/or available for download from a third party service provider (SP) such as a payment facilitator (examples of payment facilitators include, but are not limited to, Square Incorporated and iZettle). For example, a consumer or merchant may be able to obtain the two-sided payment application from one or more suppliers, such as from an application store (such as iTunes™ and/or Google Play™), from an issuer FI 116 of the consumer's payment card account, from an issuer of the merchant's payment account (such as an acquirer FI 118), and/or from a third-party applications provider (not shown).

After the two-sided payment application is installed on the consumer mobile device 102, before a first use the consumer runs or opens the two-sided payment application and registers or enrolls it as a consumer payment application by providing user or consumer data. The consumer data may include information such as the consumer's name and residential address and/or billing address, and may also include data identifying the financial and/or payment accounts (such as credit card accounts, debit card accounts, loyalty card accounts and/or gift card accounts) that have been loaded into his or her digital wallet, as well as consumer preferences data (which may concern products and/or services and/or which payment account to utilize in certain situations, and the like) and other related data. In some implementations, the consumer also provides consumer mobile device data (for example, of a type of mobile device, a mobile device brand name (which may be the manufacturer's name), a mobile device model number, and information concerning mobile device capabilities, such as the brand and model number of the consumer's mobile telephone and its capabilities). The consumer may also provide user identifiable data (or user authentication data), such as a personal identification number (PIN) and/or mobile PIN (mPIN) and/or password chosen by the user, and/or biometric data (such as a fingerprint data and/or iris scan data and/or voice data and/or pulse (heartbeat) data, and/or other types of audible data or physical data or physical activity data) which may depend on the capabilities (i.e., biometric sensor components and the like) of the consumer's mobile device. In addition, the consumer may provide personal data (such as a license plate number of the user's automobile and/or a mobile telephone identifier), and/or other data such as consumer preferences data. The user identifiable data can be used for consumer authentication purposes as applied to one or more different types of purchase transactions and/or purchase transaction contexts, and the user authentication requirements for any particular purchase transaction may be dictated by an entity such as the issuer financial institution that issued the user's credit card account (i.e., the issuer FI 116). Such data may be stored locally in the consumer's mobile device, and/or may be stored in the consumer database 110, and/or may be stored in the Cloud in some embodiments. Such consumer data may be used when authenticating the user and for authorizing a particular payment transaction. It should be understood that any particular purchase transaction will utilize whatever authentication process is required by the issuer financial institution and/or payment processing system, and thus the novel processes described herein are not limited to any particular type of authentication method.

Similarly, a merchant may obtain the same two-sided payment application in any of a number of ways. For example, the merchant may download the two-sided payment application from a service provider to the merchant mobile device 104 (for example, an iPhone™ or an Android™ smartphone), or it may have been factory-installed, or it may be provided as an operating system update by the merchant's Mobile Operating Network (MNO) provider and/or the like. As mentioned above, the two-sided payment application may be available for download or provided by, for example, one or more suppliers, such as from an application store (such as iTunes™ and/or Google Play™), a merchant acquirer FI (which issued the merchant's payment account), a third party service provider (SP) such as a payment facilitator and/or a third-party applications provider (not shown). After the two-sided payment application is installed on the merchant mobile device 104, the merchant then runs or opens the two-sided payment application, specifies that he or she will use the two-sided payment application as a merchant payment application, and then enrolls or registers by providing merchant data. The merchant data may include, for example, information or data identifying the merchant's store location(s), merchant store layout(s), merchant's financial accounts data (for example, one or more merchant accounts issued by the merchant FI 118) which may be loaded into the merchant's digital wallet. In some implementations, the merchant also provides merchant device data (for example, the brand and model type or number of the merchant's mobile telephone 104 and its capabilities). As mentioned above, instead of a merchant mobile device 104, the merchant may utilize any type of specialized electronic device, such as an electronic POS device like an electronic cash register or desktop computer that includes electronic components configured to initiate the handshake operation and establish communications with the consumer mobile device 102 as described herein. For example, the merchant may specify when registering that the merchant device is an electronic cash register having Bluetooth components that will operate to initiate the handshake operation and that will communicate with consumer mobile devices during purchase transactions. The merchant data provided during registration or enrollment may be stored in the Cloud POS database 108 for later use during a purchase transaction, for example, to receive payment data from the payment network 114 and/or the issuer FI 116 regarding a purchase transaction involving the consumer's mobile device 102.

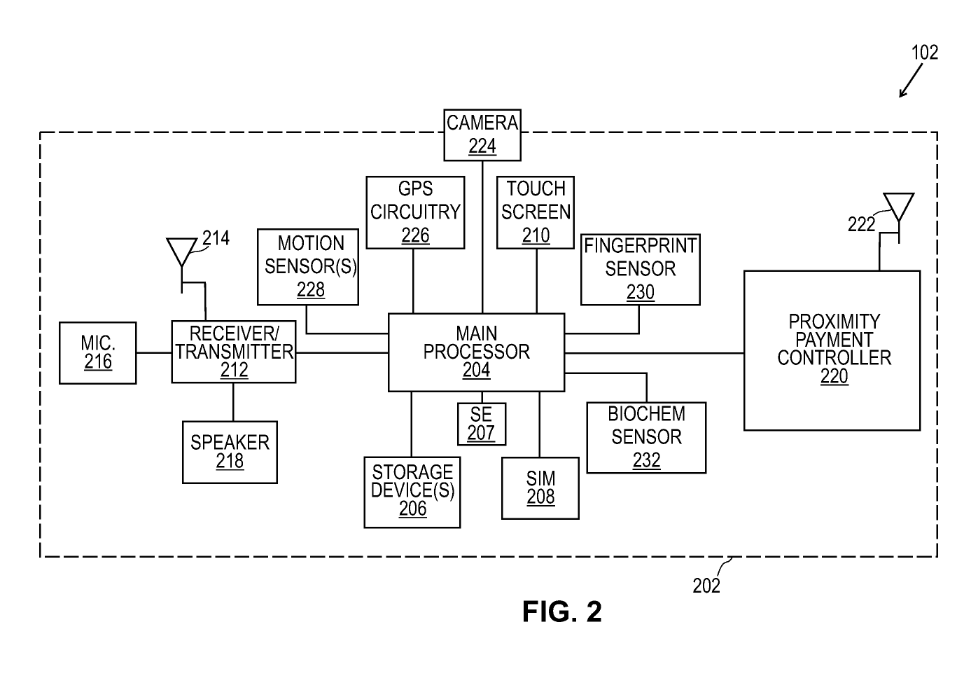

Referring again to the example system 100 of FIG. 1, after registering or enrolling, the consumer shops in a retail store of a merchant, selects merchandise and then wishes to pay for the merchandise by utilizing the consumer mobile device 102. Thus, in accordance with embodiments described herein, the consumer and the merchant both open their respective two-sided payment applications which have been installed, for example, in a secure element 207 (See FIG. 2) of their respective mobile devices. The consumer mobile device 102 then “listens” for a handshake indication 103 (such as an audible signal, a Bluetooth signal, and/or other signal) from the merchant's mobile device 104 to initialize the handshake process. In some embodiments, the merchant utilizes a Bluetooth beacon, which is an electronic device capable of detecting Bluetooth Low Energy (BLE) emanating from consumer mobile devices such as smartphones, to initialize the handshake operation and establish communications between the consumer's mobile device and the merchant's mobile device 104. One or more Bluetooth beacons can also be utilized to track the location of a consumer's mobile device as the consumer moves up and down the aisles of the merchant's store and to provide various types of data to the consumer's mobile device. For example, the consumer's mobile device may receive data that shows the location of the consumer on a map of the store, and the consumer may obtain directions using the map to where the consumer wishes to go. Coupons and/or discount offers can also be provided for items located near the consumer. In another example, the Bluetooth beacon may also determine what section of a grocery store the consumer is in, compare it to items on the consumer's shopping list that are in that area, and then transmit a reminder to the consumer (that may appear on a display screen of the consumer's mobile device) to purchase “Item X” so the consumer doesn't forget it.

It should be understood that, in some implementations, the type of handshake indication may depend on the environment in which the consumer and merchant find themselves. For example, in a dark environment, the handshake indication may comprise an audible tone (or an inaudible signal), whereas in an audibly noisy environment the handshake indication may comprise visual information or data obtained by a camera associated with the consumer's mobile device 102, which may be of a portion of the merchant's mobile device 104 or of a QR code or barcode displayed on a screen, for example. In another example, if the consumer and merchant are in an outdoor environment (for example, a bazaar or a flea market) then a geo-location signal emitted by the merchant's mobile device 104 may be utilized to initiate the handshake process. In some embodiments, one or both of the mobile devices can identify a specific process, or specific parameters or attributes to include as part of the handshake process which occurs locally (e.g., in the merchant's retail store location). After the handshake process occurs, a communications path 105, 107 via the internet 106 is formed for exchanging purchase transaction details (which may be, for example, item or merchandise data in an electronic shopping cart of the consumer's mobile device) and/or the exchange of data and/or information as described herein.

In some embodiments, after a successful handshake operation, the consumer mobile device 102 transmits the purchase transaction details (for example, the transaction amount, itemized merchandise data, and/or other transaction details) to the merchant mobile device 104 via the internet 106 The consumer's mobile device 102 may also transmit the purchase transaction data to the mobile gateway computer network 112 for forwarding to the payment network 114 for further processing. In some implementations, the mobile gateway computer 112 first determines whether or not to authenticate the consumer and/or the consumer's mobile device 102 based on any suitable authentication process (for example, the consumer may be prompted to enter or provide a personal identification number (PIN) and/or a passcode and/or biometric data by the two-sided payment application, which is then transmitted to the mobile gateway computer or a third party provider for authentication processing). Consumer authentication is beyond the scope of the present application, and thus will not be discussed in detail herein. It is sufficient to understand that if the consumer and/or the consumer mobile device is/are authenticated, then the mobile gateway computer 112 forwards the purchase transaction data along with an authorization request to the payment network 114 for payment authorization processing. The payment network 114 next utilizes consumer identification data in the authorization request to determine which issuer financial institution (FI) 116 to direct the purchase transaction authorization request, and then transmits the authorization request to that issuer FI. The issuer FI 114 then determines whether or not to authorize the purchase transaction (for example, if the consumer's credit card account has an adequate credit line to cover the cost for the purchase transaction then it will be authorized). If the issuer FI authorizes the purchase transaction, the payment network 114 then will forward the authorization to the merchant acquirer FI for payment, and in some implementations transmits a purchase transaction authorization message to both the consumer's mobile device 102 and the merchant's mobile device 104 to consummate the transaction. The merchant then permits the consumer to take the selected merchandise out of the retail store location.

FIG. 2 is a block diagram of an embodiment of a consumer's mobile device 102 to illustrate some hardware aspects. In this example, the user's mobile device is a mobile telephone 102 (see FIG. 1, which may be a Smartphone) that may, but need not, have capabilities for functioning as a contactless payment device. In particular, the user's mobile device 102 may be any type of mobile device capable of utilizing the two-sided payment application to carry out payment transactions in a payment card system according to the methods described herein. In some embodiments, the novel functionality described herein may result at least partially from software and/or firmware that improves and/or transforms one or more components such as one or more controllers and/or processors of the mobile telephone 102.

The mobile telephone 102 may include a conventional housing (indicated by dashed line 202) that contains and/or supports the other components of the mobile telephone 102. In this example embodiment, the mobile telephone 102 includes a main mobile processor 204 for controlling over-all operation of the mobile telephone 102. The main mobile processor 204 is suitably programmed to allow the mobile telephone 102 to engage in data communications and/or text messaging with other wireless devices and/or electronic devices, and to allow for interaction with web pages accessed via browser software, which is not separately shown. Other components of the mobile telephone 102, which are in communication with and/or are controlled by the control circuitry or main mobile processor 204, include one or more storage devices 206 (for example, non-transitory program memory devices and/or working memory, and the like), a secure element (SE) 207, a conventional subscriber identification module (SIM) card 208, and a touch screen display 210 for displaying information and for receiving user input.

The mobile telephone 102 also includes conventional receive/transmit circuitry 212 that is also in communication with and/or controlled by the main mobile processor 204. The receive/transmit circuitry 212 is operably coupled to an antenna 214 and provides the communication channel(s) by which the mobile telephone 102 communicates via the mobile network (not shown). The mobile telephone 102 further includes a microphone 216 operably coupled to the receive/transmit circuitry 212. The microphone 216 may be utilized for various purposes, such as for receiving voice input from the user and, for example, also for listening for a signal or tone emitted by another electronic device (i.e., a merchant's mobile device) to initiate a handshake process. In addition, a loudspeaker 218 is operably coupled to the receive/transmit circuitry 212 and provides sound output to the user.

The mobile telephone 102 may also include a proximity payment controller 220 which may be an integrated circuit (IC) or chipset of the type commonly embedded in contactless payment cards. It should be understood, however, that a mobile device capable of conducting a transaction using the novel two-sided payment application processes described herein, need not include such a proximity payment controller 220 and need not include proximity payment functionality. In this example, the proximity payment controller 220 is operably connected to an antenna 222 and can function to interact with a Radio Frequency Identification (RFID) and/or Near Field Communication (NFC) proximity reader (not shown), which may be associated, for example, with a Point-of-Sale (POS) terminal of a merchant. In some embodiments, the secure element (SE) chip 207 may be utilized to store a contactless payment application and/or to store the two-sided payment application.

As shown in FIG. 2, the mobile telephone 102 may also include one or more sensors and/or circuitry and/or devices and/or components that function to provide data concerning the consumer's mobile device and/or the user or consumer. In particular, the mobile telephone 102 may be a Smartphone that includes an integrated camera 224 operably connected to the main processor 204 and that can be utilized for various functions. For example, the integrated camera 224 can take pictures or photographs that may be stored on the mobile device 102 or shared with others, can be operated to read a two-dimensional (2D) barcode to obtain information from another mobile device (such as identification information associated with a merchant's mobile device), can be utilized to take a photograph of a merchant's mobile device or portion thereof for identification purposes (for example, in order to initiate a handshake process), and/or can be operated to take a picture of the user or consumer for authentication purposes. The mobile telephone 102 may also include Global Positioning System (GPS) circuitry 226 operably connected to the main processor 204. The GPS circuitry 226 generates information concerning the location of the mobile telephone 102.

The mobile telephone 102 may also include one or more motion sensor(s) 228, a fingerprint sensor 230, and a biochemical sensor 232. In some embodiments, one or more of these components may be utilized in concert with the two-sided payment application. The motion sensor(s) 228 may be operable to generate motion data, for example, that can be associated with the user's walking style or gait, and/or to generate force data associated with, for example, the force generated by the user's finger when he or she touches the touch screen 210. The fingerprint sensor 230 may include a touch pad or other component (not shown) for use by the user to swipe his or her index finger when fingerprint data is required for an operation (such as for user authentication purposes concerning a transaction, and/or for entry to a building). The biochemical sensor 232 may include one or more components and/or sensors operable to obtain biological data, such as breath data (and/or other types of data associated with the user) from the user of the mobile device 102.

Thus, the main processor 204 and receiver/transmitter circuitry 212 may function according to instructions of the two-sided payment application to transmit, for example, generated GPS data and/or motion data and or biometric data to the consumer database 110, and/or to the Cloud POS database 108, and/or to the mobile gateway computer 112 (see FIG. 1) for processing during a purchase transaction. The user's mobile device may also contain one or more additional sensors, such as an iris scanner device (not shown) for generating iris scan data, or a pulse sensor for obtaining heartbeat data, which may be useful for identifying biometric or other personal data of a consumer.

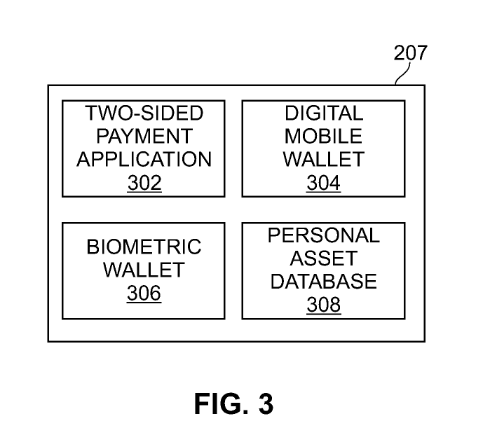

FIG. 3 is a block diagram of a secure element 207 or memory of a consumer's payment-enabled mobile device to illustrate some software aspects according to embodiments of the disclosure. As described earlier, after enrolling or registering, the consumer downloaded the two-sided payment application 302 into the secure memory 207 of his or her mobile device 102. The consumer also set-up and/or loaded a digital mobile wallet 304 that contains personal financial data, such as data concerning one or more credit card accounts, debit card accounts, reward card accounts, gift card accounts, merchant loyalty card accounts, and/or other types of financial accounts and the like. As is known, such a digital wallet can be used by the consumer to conduct electronic payment transactions with a merchant, for example, by selecting a payment card account from the digital wallet and then providing identification data (such as a mobile personal identification number (mPIN)) that authenticates the consumer to the payment network 114 (see FIG. 1). The payment network 114 then coordinates processing between an issuer financial institution (FI) 118 that issued the consumer's payment card account, and an acquirer FI 118 associated with the merchant. If all is in order (i.e., the payment system authenticated the consumer and was informed that the consumer's payment card account has a sufficient credit line to cover the transaction amount thus authorizing the purchase transaction), then the purchase transaction is consummated. In accordance with processes disclosed herein, the consumer may enroll in and utilize a two-sided payment application to easily and securely conduct purchase transactions locally without the need to remember a personal identification number (PIN) (such as an mPIN) or a password. It should be understood that, in some embodiments, consumers, payment networks, Issuer FIs and/or Acquirer FIs may also be required to enroll or to register with a two-sided payment application service platform (for example, via a website or webpage hosted by a service provider) before two-sided payment application processing can occur as described herein.

Referring again to FIG. 3, in some embodiments, two-sided payment application program 302 is operable to perform a handshake operation with a merchant mobile device that is running the same two-sided payment application, as described herein. The two-sided payment application may also be configured to determine a type of transaction that is occurring, and then, based on that data and data supplied by the consumer during registration, to prompt the mobile device user for one or more of user identifiable biometric data, personal data, and/or social media data in order to authenticate the user or consumer. Thus, during the registration or enrollment process, the user may also be prompted to utilize a touch screen 210 and/or biometric sensors 230, 232 (see FIG. 2) of the user's or consumer's mobile device 102 to enter personally identifiable biometric data, which may then be stored in the biometric database (not shown) or the consumer database 110 (see FIG. 1) and stored in a biometric wallet 306 of the user's mobile device 102. Examples of biometric data which may be obtained from a consumer or user and stored in the biometric database and/or in the biometric wallet 306 includes, but is not limited to, face data (i.e. a picture taken with a mobile device camera of the user's face, and/or iris scan data), fingerprint data, voice data, audible data (for example, voice data and/or hand clapping sounds), a walking style data, and/or signature data.

In some embodiments, the user may also be prompted during the registration process to enter personally identifiable assets data by, for example, utilizing the touch screen or keyboard (not shown) of the user's mobile device. The personal assets data may be stored in the consumer database 110 (see FIG. 1) and/or in a personal assets wallet 308 of the secure element 207. Examples of personal assets data which may be obtained from the consumer and stored in the consumer database 110 and/or in the personal assets wallet 308 includes, but is not limited to, license plate data (i.e. the state in which the license was issued and the plate number), a mobile telephone number, automobile data (i.e., the make, year, type and color of the user's automobile; such as a 2012 silver Toyota Camry four door sedan), motorcycle data (.e., the make, year, type and color of the user's motorcycle; such as a 2010 blue Harley Davidson Road King), and/or any other information associated with a personal asset that is personally identifiable to the user. Such data may be utilized in some circumstances and/or situations to authenticate the consumer before permitting further transaction processing.

In some embodiments, the two-sided payment application 302 includes instructions operable to cause a processor of the consumer's mobile device to periodically and/or automatically communicate with the two-sided payment application service provider to check for any updates and the like. Thus, in some embodiments, the two-sided payment application program may automatically download updated data and/or updated information and or application instruction updates when found. In addition, if there are any updates to business rules by one or more issuer financial institutions concerning one or more of the payment card accounts in the user's mobile digital wallet 304, then such updates may also be downloaded because one or more of such updated rules may impact the level of security and/or the types of data required from the consumer for use during future purchase transactions and/or for other transactions or activities (such as entry to a secure building). The two-sided payment application program 302 may also be configured to upload data and/or information from the consumer's mobile device 102 to, for example, the consumer database 110 and/or issuer FI computer 116 and/or the two-sided payment application service provider (not shown) if necessary to update and/or change personal asset data and the like.

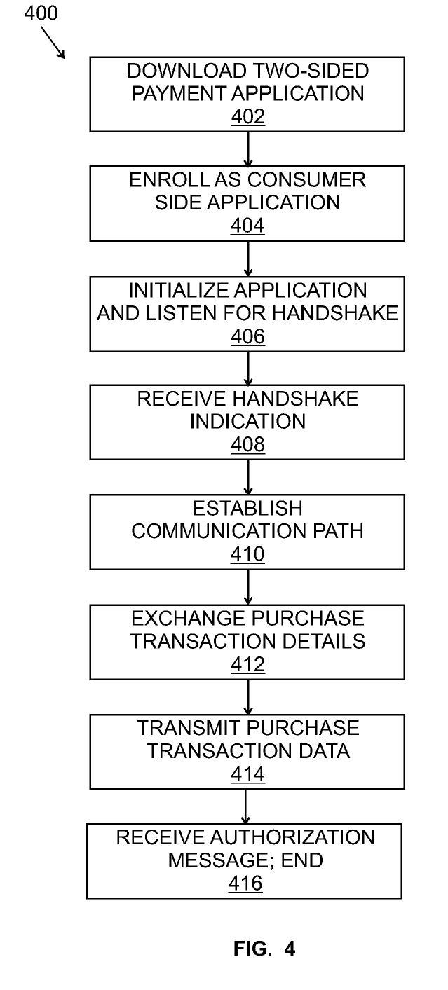

FIG. 4 is a flowchart of a two-sided payment application transaction process 400 between a consumer mobile device and a merchant device in accordance with aspects described herein. A consumer downloads 402 a two-sided payment application from, for example, an application store by using his or her consumer mobile device, or is otherwise provided with the two-sided payment application (for example, the two-sided payment application may be pre-loaded by the consumer mobile device manufacturer, or provided with an operating system update by a third party service provider). The consumer then runs or opens the two-sided payment application and enrolls 404 or registers as a consumer by providing consumer data. The consumer data may include information identifying the consumer's financial and/or payment accounts (such as credit card accounts, debit card accounts, loyalty card accounts and/or gift card accounts) that have been loaded into his or her digital wallet, and may include consumer mobile device data (for example, the brand and model of the consumer's mobile telephone and its capabilities). The consumer may also provide user preferences data and consumer identifiable data, such as a personal identification number (PIN) or password. The consumer identifiable data may also include biometric data (such as a fingerprint data and/or iris scan data and/or voice data and/or other types of audible data or physical activity data) which may depend on the capabilities and/or electronic components of the consumer's mobile device. In addition, the consumer may provide personal data (such as a license plate number of the user's automobile and/or a mobile telephone number and/or mobile telephone identifier).

Referring again to FIG. 4, after the consumer has downloaded the two-sided payment application and enrolled, he or she shops in a merchant retail store location and selects items or merchandise for purchase. In some embodiments, the two-sided payment application may initialize 406 automatically upon entry into a merchant's store, or may be initialized by the consumer upon entry. In some other embodiments, when the consumer wishes to exit with items selected while shopping, the consumer initializes 406 the two-sided payment application. In any case, once the two-sided application is initialized, it listens for a handshake indication from a merchant device. When the consumer's mobile device receives 408 or detects a handshake indication, the consumer's mobile device then establishes 410 a communications path, for example via the internet, for exchanging data and/or information such as transaction details. The consumer mobile device next exchanges 412 purchase transaction details data (for example, the transaction amount, itemized merchandise data, and/or other transaction details which may be in an electronic shopping card of the consumer's mobile device) with the merchant device. Next, the consumer mobile device transmits 414 the purchase transaction data to a mobile gateway computer network for transaction processing. In some implementations, the consumer may also be prompted to provide authentication information (for example, the consumer may be prompted to enter or provide a personal identification number (PIN) and/or a passcode and/or biometric data by the two-sided payment application), which is then transmitted to the mobile gateway computer or a third party provider for authentication processing. If the purchase transaction is authorized, the consumer mobile device receives 416 a purchase transaction authorization message, and the process ends. The consumer is then permitted to take the selected merchandise out of the retail store location.

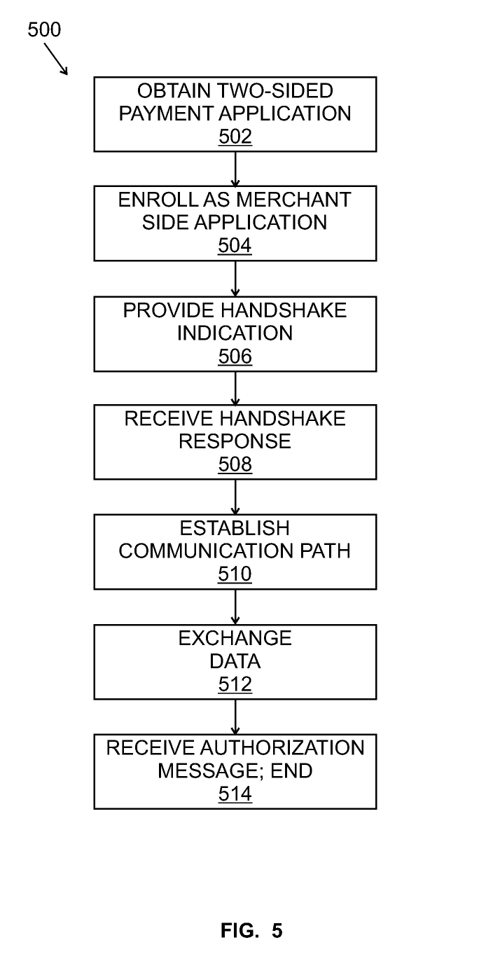

FIG. 5 is a flowchart of a two-sided payment application transaction process 500 from the point of view of the merchant utilizing a merchant device in accordance with aspects described herein. A merchant obtains 502 a two-sided payment application from, for example, a merchant issuer financial institution, or a third party provider, or from an application store. In some embodiments, the two-sided payment application may be pre-loaded by a merchant device manufacturer, or provided with an operating system update or upgrade by a third party service provider. The merchant then runs or opens the two-sided payment application and enrolls 504 or registers as a merchant or a merchant-side application by providing merchant data. The merchant data may include information identifying the merchant's acquirer financial institution and/or merchant payment account(s), and may include information concerning merchant loyalty card accounts and the like. The merchant may also provide merchant device data (for example, the brand and model of the merchant's mobile telephone or tablet computer or specialty POS device (i.e., electronic cash register) and its capabilities). The merchant may also be prompted to provide merchant device contact information so that remote communications can be initiated and occur between the merchant device and consumer mobile devices when purchase transactions occur.

Referring again to FIG. 5, the merchant provides 506 a handshake indication, which be provided in any number of ways. For example, if the merchant owns large retail stores, then there may be multiple Bluetooth beacon devices which can cause a handshake signal to be transmitted once a consumer's mobile device has been detected. In some embodiments, such a merchant may continually broadcast a handshake signal during store operating hours which can be received by consumer mobile devices. In yet other embodiments, a merchant device may only transmit a handshake indication when a consumer has finished shopping in the retail store and approaches the merchant or merchant employee to check out. Thus, when the merchant's device receives 508 a handshake response, then the merchant device establishes 510 an communication path with the consumer's mobile device and exchanges 512 data. The data exchanged may include transaction details such as the transaction amount, itemized merchandise data, and/or other transaction details (which may be transmitted to the merchant's device from an electronic shopping card of the consumer's mobile device). In some embodiments, the consumer mobile device transmits the purchase transaction data to a mobile gateway computer network for transaction processing, and then (if the consumer was authenticated and the consumer's payment account was authorized for payment) the merchant device receives 514 a purchase transaction authorization message, and the process ends. The merchant then permits the consumer to take the selected merchandise out of the retail store location.

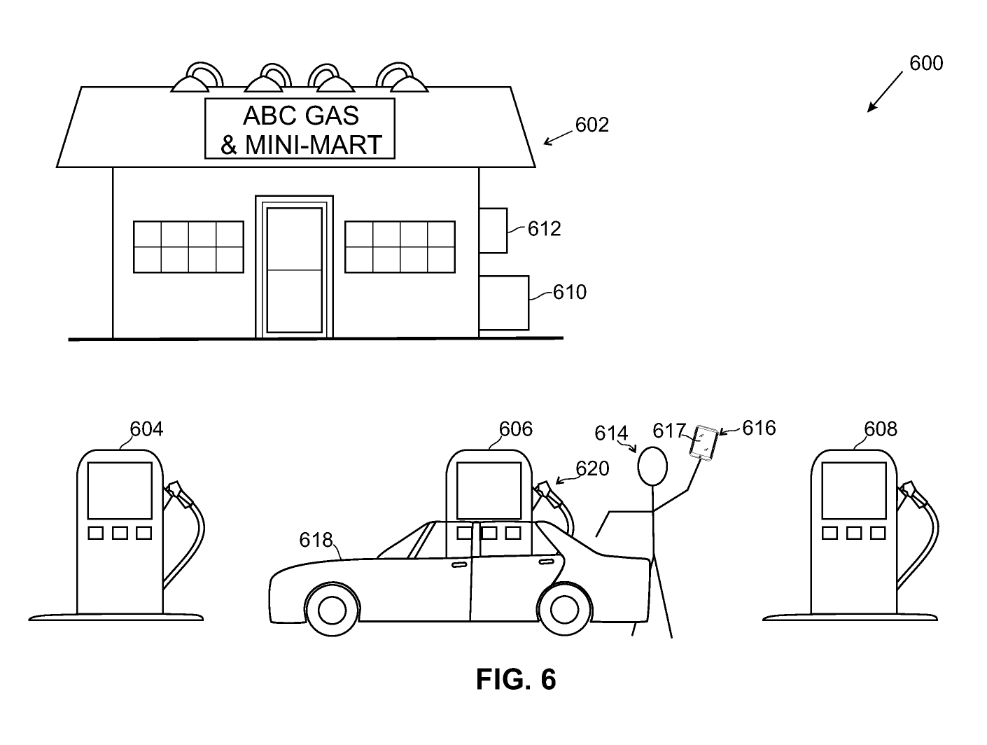

FIG. 6 is a schematic block diagram 600 of an unattended location wherein a merchant device includes a two-sided payment application operable to conduct payment transactions with consumer mobile devices in accordance with embodiments of the disclosure. In particular, FIG. 6 shows an “ABC Gas and Mini-Mart” gasoline station 602 and three gas pumps 604, 606 and 608 capable of dispensing three different grades of gasoline, which may be labeled as “regular,” “plus” and premium.” Each of the gas pumps 604, 606 and 608 may include a transceiver and other electronic components (not shown) capable of communicating with a specialized merchant device 610, which merchant device is also capable of interacting with a WiFi hotspot device 612 to transmit and receive data and/or information via the internet and/or other computer networks (not shown). A consumer 614 having a consumer mobile device 616 pulls his car 618 into the gasoline station 602 and stops adjacent to the gas pump 606 and wants to fill the gas tank (not shown) of the car 618 with “premium” grade gasoline. The consumer 614 turns on his consumer mobile device 616 (if it was not already in the “On” state) and initiates the two-sided payment application. The two-sided payment application, running as a consumer-side application, receives a handshake indication signal from a merchant's two-sided payment application, which is running on the merchant device 610, and establishes a communication path. In some embodiments, the consumer 614 receives a transaction request on a display screen 617 of the consumer mobile device 616 to enter information such as the grade of gasoline desired, the total amount that he wishes to spend on the purchase of gasoline, and payment card account details for providing payment. The consumer 614 responds by entering the requested information and then pushing an “enter” radio button (not shown) on his display screen 617 to transmit the information to the merchant's checkout system for processing. The consumer 614 is unaware that this exchange of information including his gasoline selection and purchase transaction details is actually occurring over a remote network or system, and in many cases the consumer may assume that the transaction is being handled locally by the gasoline station 602 (i.e., by the merchant). For example, in some embodiments the transaction request and the consumer's purchase transaction response information is received from and transmitted to the WiFi hotspot device 612, which may forward the transaction response information to a mobile gateway computer network (not shown) for transaction processing. If the consumer is authenticated and the consumer's payment account is authorized for payment, then a purchase transaction authorization message is received by the consumer mobile device 616 from the WiFi hotspot device 612 and displayed on the display screen 617. The merchant device 610 also receives the purchase transaction authorization message, and then causes the gasoline pump 606 to be energized to provide “premium” grade gasoline when the consumer 614 places the nozzle 620 of the gas pump 606 into the opening in the car that leads to the gas tank. Thus, the consumer 614 does not have to walk into the building 602 to pay a cashier for gasoline, and the merchant does not have to employ anyone to pump gasoline into cars. In addition, one merchant device 610 can be used to broadcast a handshake signal that covers the area around all of the gasoline pumps 604, 606 and 608. Such a system may be configured to operate twenty-four (24) hours per day, and thus may be operable to provide service to consumers even during hours when the “ABC Gas and Mini-Mart” station building 602 is closed and/or locked.

Other types of “unattended” type applications and/or uses are contemplated. For example, a long-term parking lot at an airport may include merchant devices configured to advantageously operate in accordance with the processes described herein. In particular, consumers may park their cars for days or weeks at such long-term lots and then come back from a trip at any or all hours of the day or night to collect their car and drive off the lot. Such consumers can operate their consumer mobile device and two-way payment application to communicate their arrival and parking of their vehicle with a merchant device running the two-way payment application, and communicate again upon return to pay for the parking and be permitted to leave the parking lot (which all can occur without an attendant being present). The merchant can advantageously utilize one or more merchant devices in strategic locations to cover all entrances and exits to the parking lot to facilitate communications, payment and exiting. In another example, a merchant device may be configured to run a two-way payment application with regard to collecting toll fees from vehicle drivers. For example, a toll operator may position a toll device to cover one or more toll booths wherein the toll device runs a two-way application operable to communicate with Bluetooth-enabled consumer devices associated with vehicles that come into a toll lane. The toll device may broadcast a Bluetooth handshake signal, and then communicate with a particular vehicle driver via the driver's mobile device in a toll lane to receive information and/or payment, and then be configured to allow that car to pass by raising a barrier such that the vehicle can pass through the toll area and continue on the toll-road or cross over a toll-bridge.

In yet another example, since any type of data or information may be exchanged after a successful handshake operation between a consumer mobile device and a merchant device running the two-sided payment application, a consumer device may receive a menu of food and drink items while in a drive-in restaurant parking lot by utilizing the consumer two-way payment application on his or her consumer mobile device. The consumer may then be prompted to make menu selections, prompted to pay for the food and/or drink order, and then have the food and/or drinks delivered to his car by a restaurant employee. This is possible because the merchant device will receive information regarding the food and/or drink order, information regarding the location of the vehicle in the parking lot, and confirmation of payment for the order. Thus, many different types of relevant and/or valuable information may be exchanged between the consumer mobile device and the merchant device running the two-sided payment application in addition to the purchase transaction data and/or payment data. For example, a grocery store may configure the merchant device to transmit coupon and/or discount offers to consumer mobile devices when consumers enter their retail store, and may also transmit survey questions to the consumer mobile devices upon checkout.

It should be understood that, in some embodiments of the novel processes described herein, the consumer utilizes a mobile device such as an iPad™ or iPhone™ but the merchant may utilize a different type of electronic device, which is not necessarily a mobile device. For example, as described earlier the merchant may utilize an electronic Point-of-Sale (POS) device (such as an electronic cash register or desktop computer) that is not portable, but that functions to run the two-sided payment application and transmit a handshake indication by, for example transmitting a signal and/or using a display screen and/or using one or more other components configured to initiate the handshake operation, and which is capable of exchanging data and/or information with the consumer's mobile device as described herein. Such an electronic POS device also is capable of receiving information and/or data from remote computers and/or computer networks in the manner described herein. Thus, the two-sided application can be used with many different types of consumer mobile devices, and such consumer mobile devices can also be advantageously integrated into and/or utilized with existing merchant systems without the merchant having to make any changes to the merchant's system hardware.

Such a process is easy to implement and is secure, and the authentication and/or transaction authorization processes appears to the consumer to have been handled locally, in the merchant's retail location. Thus, this type of payment transaction process may be considered to be an in-application payment method, and it can be accomplished with various mechanisms and at different security levels as disclosed herein.

As used herein and in the appended claims, the term “computer” should be understood to encompass a single computer or two or more computers in communication with each other or a computer network or computer system. In addition, as used herein and in the appended claims, the term “processor” should be understood to encompass a single processor or two or more processors in communication with each other. Moreover, as used herein and in the appended claims, the term “memory” should be understood to encompass a single memory or storage device or two or more memories or storage devices. Such a memory and/or storage device may include any and all types of non-transitory computer-readable media, with the sole exception being a transitory, propagating signal.

The flow charts and descriptions thereof herein should not be understood to prescribe a fixed order of performing the method steps described therein. Rather, the method steps may be performed in any order that is practicable. In addition, the flow charts described herein should not be understood to require that all steps or elements be practiced in every embodiment. For example, one or more elements or steps may be omitted in some embodiments.

Although the present disclosure describes specific exemplary embodiments, it should be understood that various changes, substitutions, and alterations apparent to those skilled in the art can be made to the disclosed embodiments without departing from the spirit and scope of the disclosure as set forth in the appended claims.

What is claimed is:

1. A method for conducting a purchase transaction between a consumer mobile device and a merchant device, comprising:
initializing, by a mobile device processor of a consumer mobile device, a two-sided payment application for conducting a purchase transaction;
receiving, by the mobile device processor, a handshake indication from a merchant device processor of a merchant device running a copy of the two-sided payment application, the handshake indication received by the consumer mobile device at a merchant location;
establishing, by the mobile device processor and the merchant device processor, a communications path between the consumer mobile device and the merchant device via a remote network connection;
exchanging, by the mobile device processor and the merchant device processor, purchase transaction detail data via the remote network connection;
transmitting, by the mobile device processor, the purchase transaction detail data via the remote network connection to a mobile gateway computer for authorization processing;
receiving, by the mobile device processor from the mobile gateway computer via the remote network connection, an authorization message; and
receiving, by the merchant device processor from the mobile gateway computer via the remote network connection, the authorization message to consummate the purchase transaction.

2. The method of claim 1, further comprising, prior to initializing the two-sided payment application:
receiving, by the mobile device processor of the consumer mobile device, the two-sided payment application; and
registering, by the mobile device processor, the two-sided payment application as a consumer payment application.

3. The method of claim 2, wherein registering further comprises transmitting, by the mobile device processor to a two sided-payment application database, at least one of consumer data, consumer mobile device data, user identifiable data, and personal data of the consumer.

4. The method of claim 3, wherein the consumer device data comprises at least one of a consumer name, residential address, billing address, consumer payment accounts data, and consumer preferences data.

5. The method of claim 3, wherein the consumer mobile device data comprises at least one of a type of mobile device, a mobile device brand, a mobile device model number, and information concerning mobile device capabilities.

6. The method of claim 3, wherein the user identifiable data comprises at least one of a personal identification number (PIN), a mobile PIN (mPIN), a user password, or biometric data.

7. The method of claim 1, wherein the two-sided payment application is factory installed on at least one of the consumer mobile device and the merchant device.

8. The method of claim 2, wherein the two-sided payment application is received by the mobile device processor from one of a mobile network operator (MNO), an issuer financial institution, or an application store.

9. The method of claim 1, further comprising, prior to initializing the two-sided payment application:
receiving, by the merchant device processor of the merchant device, a copy of the two-sided payment application; and
registering, by the merchant device processor, the copy of the two-sided payment application as a merchant payment application.

10. The method of claim 9, wherein registering further comprises transmitting, by the merchant device processor, at least one of merchant data and merchant device data to a two sided-payment application database.

11. The method of claim 10, wherein the merchant data comprises at least one of merchant financial account data, merchant store location data, and merchant store layout data.

12. A system for conducting a purchase transaction, comprising:
a consumer mobile device comprising a mobile device processor operably connected to a storage device;
a merchant device comprising a merchant device processor operably connected to a merchant storage device;
a two-sided payment application database;
a mobile gateway computer; and
a network operably connected to the consumer mobile device, the merchant device, the two-way payment application database, the POS database, and the mobile gateway computer, wherein the network is configured for facilitating communications between the consumer mobile device, the merchant device and the mobile gateway computer;
wherein the storage device of the consumer mobile device stores instructions configured to cause the mobile device processor to:
initialize a two-sided payment application for conducting a purchase transaction;
receive a handshake indication from the merchant device processor running a copy of the two-sided payment application, the handshake indication received by the consumer mobile device at a merchant location;
establish a communications path between the consumer mobile device and the merchant device via connection to the network;
exchange purchase transaction detail data via the network connection;
transmit the purchase transaction detail data via the remote network connection to the mobile gateway computer for authorization processing;
receive an authorization message from the mobile gateway computer via the remote network connection;
and wherein the merchant device processor also receives the authorization message from the mobile gateway computer via the remote network connection to consummate the purchase transaction.

13. The system of claim 12, wherein the storage device of the consumer mobile device stores further instructions, prior to the instructions for initializing the two-sided payment application, configured to cause the mobile device processor to:
receive the two-sided payment application and load it in secure storage; and
register the two-sided payment application as a consumer payment application.

14. The system of claim 13, wherein the instructions for registering further comprises instructions configured to cause the mobile device processor to transmit to a two-sided payment application database at least one of consumer data, consumer mobile device data, user identifiable data, and personal data of the consumer.

15. The system of claim 12, wherein the storage device of the consumer mobile device stores further instructions, prior to the instructions for initializing the two-sided payment application, configured to cause the mobile device processor to:
receive the two-sided payment application and load it in secure storage; and
register the two-sided payment application as a consumer payment application.

16. The system of claim 12, wherein the merchant storage device of the merchant device stores instructions configured to cause the mobile device processor to:
receive a copy of the two-sided payment application; and
register the copy of the two-sided payment application as a merchant payment application.

17. The system of claim 16, wherein the instructions for registering the two-sided payment application as a merchant payment application comprise instructions configured to cause the mobile device processor to transmit at least one of merchant data and merchant device data to the two sided-payment application database.
